(19) United States
(12) Patent Application Publication
(10) Pub. No.: US 2025/0003811 A1
(43) Pub. Date: Jan. 2, 2025

(54) THERMISTOR ASSEMBLY, TEMPERATURE SENSOR, AND MANUFACTURING METHODS THEREOF

(71) Applicant: Yazaki Corporation, Tokyo (JP)

(72) Inventor: Daichi MURAMOTO, Makinohara-shi (JP)

(73) Assignee: Yazaki Corporation, Tokyo (JP)

(21) Appl. No.: 18/744,907

(22) Filed: Jun. 17, 2024

(30) Foreign Application Priority Data
Jun. 28, 2023 (JP) 2023-105621

(51) Int. Cl. G01K 7/22

(52) U.S. Cl. CPC G01K 7/22

(57) ABSTRACT

A thermistor assembly includes a thermistor; two lead members with rigidity; and a first resin portion, wherein first end portions of the two lead members are connected with the thermistor, and the thermistor is sealed by the first resin portion.

### TECHNICAL FIELD

The present invention relates to a thermistor assembly, a temperature sensor, and manufacturing methods thereof.

### BACKGROUND ART

There is a temperature sensor using a thermistor. As a manufacturing method of such temperature sensor, there is a method of injecting a packing resin into a protective case, and then inserting a thermistor assembly including a thermistor and a lead wire into the packing resin inside this protective case.

As the thermistor assembly, a thermistor sealed in glass is known (see Patent Document 1). According to the thermistor assembly by sealing the thermistor in the glass, a Dumet wire, which has a thermal expansion coefficient close to that of the glass is used as the lead wire.

### CITATION LIST

### Patent Documents

[Patent Document 1] JP 6405074B

### SUMMARY OF THE INVENTION

### Technical Problem

The Dumet wire is soft and may bend when inserting the thermistor assembly into the packing resin such that it is difficult to accurately position it with respect to the protective case of the thermistor.

Therefore, a solution of further connecting a lead wire having rigidity to the Dumet wire, having the glass sealing the thermistor and the Dumet wire to be sealed by the sealing resin, and then inserting the thermistor assembly into the packing resin is provided. The sealing resin is formed by dipping, and a shape and dimensions of the sealing resin are not stable. In this case, although the lead wires do not bend, it is difficult to accurately position the thermistor with respect too the protective case due to the instability of the shape and dimensions of the sealing resin.

Accordingly, an object of the present invention is to provide a temperature sensor in which a thermistor is accurately positioned with respect to the case.

### Solution to Problem

In order to solve the above-described technical problem, a thermistor assembly according to an embodiment of the present invention includes a thermistor; two lead members with rigidity; and a first resin portion, wherein first end portions of the two lead members are connected with the thermistor, and the thermistor is sealed by the first resin portion.

A temperature sensor according to an embodiment of the present invention includes the above-described thermistor assembly; a case having an accommodation area that is open in a second direction; and a second resin portion, wherein the second resin portion is disposed in the accommodation area so as to seal the first resin portion.

A manufacturing method for manufacturing a thermistor assembly according to an embodiment of the present invention includes a connection step of connecting a thermistor to first end portions of two lead members having rigidity; and a molding step of molding a first resin portion by a transfer molding such that the thermistor is sealed by the first resin portion.

A manufacturing method according to an embodiment of the present invention is a manufacturing method for manufacturing a temperature sensor including a connection step of connecting a thermistor to first end portions of two lead members having rigidity; a molding step of molding a first resin portion by a transfer molding such that the thermistor is sealed by the first resin portion; an injection step of injecting resin into an accommodation area of a case; an insertion step of inserting the thermistor assembly into the resin such that the first resin portion is sealed by the resin that is injected into the accommodation area of the case, and a curing step of curing the resin.

### Effect of the Invention

According to the present invention, it is possible to provide a temperature sensor in which a thermistor is accurately positioned with respect to the case.

### BRIEF DESCRIPTION OF THE DRAWINGS

FIG. 1 is a view showing a temperature sensor according to an embodiment of the present invention.

FIG. 2 is a front view of the temperature sensor 100.

FIG. 3 is a sectional view of the temperature sensor 100 along a section AA of FIG. 2.

FIG. 4 is a sectional view of the temperature sensor 100 along a section BB of FIG. 2.

FIG. 5 is a sectional view of the temperature sensor 100 along a section CC of FIG. 2.

FIG. 6 is a view showing a thermistor assembly 110.

FIG. 7 is a view for describing a relationship between a thermistor 111 and two lead members 112.

FIG. 8 is a view showing another example of the thermistor assembly 110.

FIG. 9 is a view showing a relationship between a lead member 112 and a second resin portion 130.

FIG. 10 is a view showing an example of a manufacturing method of the temperature sensor 100.

### DESCRIPTION OF EMBODIMENTS

### Temperature Sensor 100

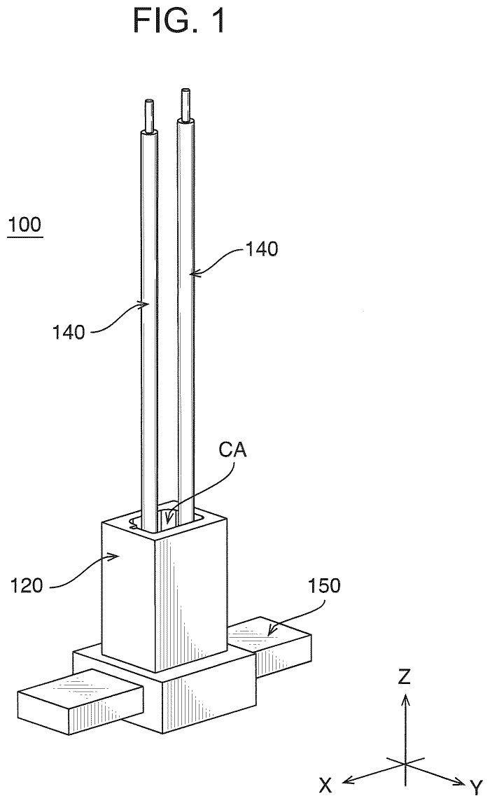

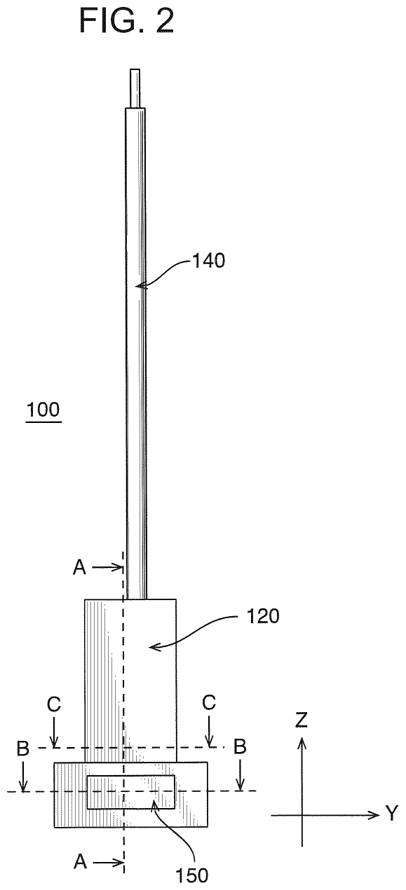

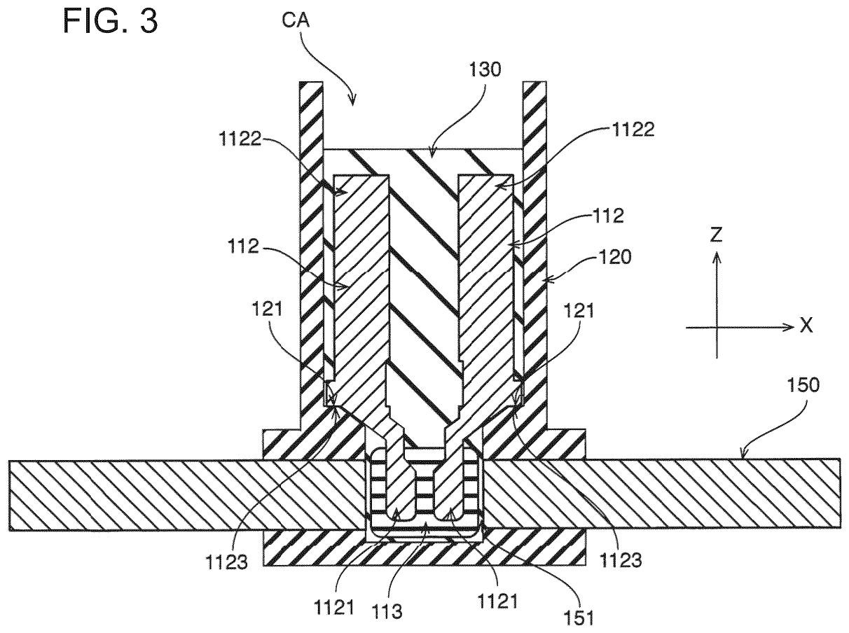

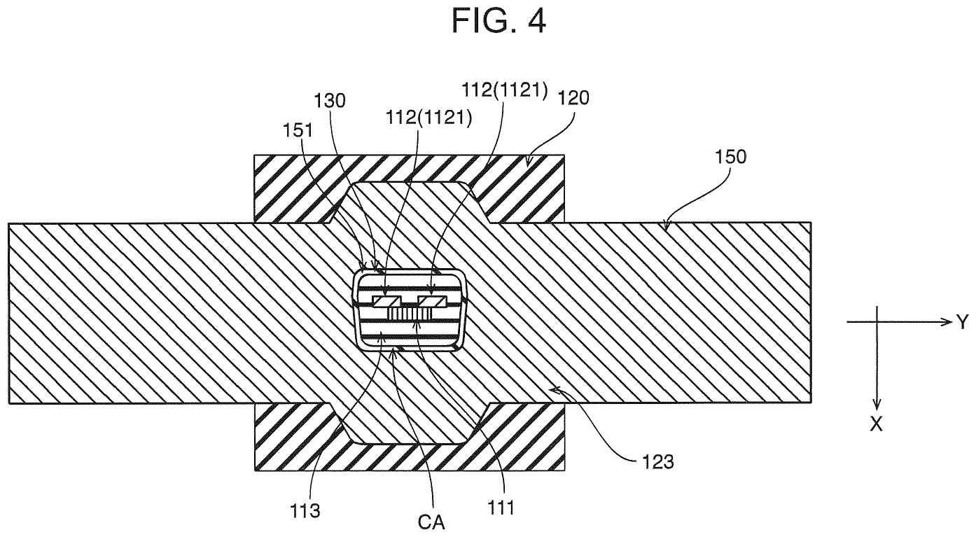

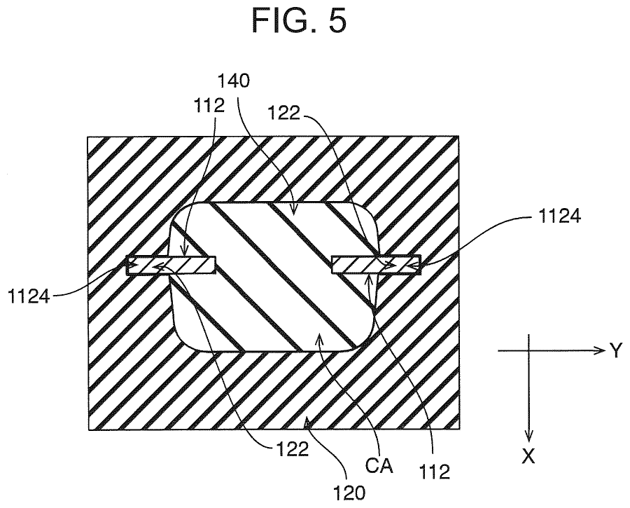

FIG. 1 is a view showing a temperature sensor 100 according to an embodiment of the present invention. FIG. 2 is a front view of the temperature sensor 100, FIG. 3 is a sectional view showing the temperature sensor 100 along a section AA in FIG. 2, FIG. 4 is a sectional view showing the temperature sensor 100 along a section BB in FIG. 2, and FIG. 5 is a sectional view showing the temperature sensor 100 along a section CC in FIG. 2. In FIG. 1, an upper direction is a direction Z, and two directions being orthogonal to the direction Z is a direction X and a direction Y.

The temperature sensor 100 includes a thermistor assembly 110, a case 120, and a second resin portion 130.

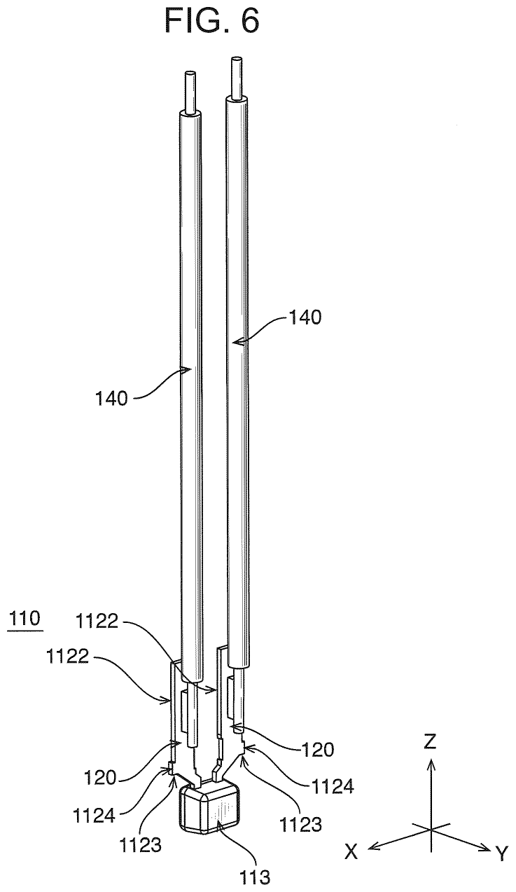

FIG. 6 is a view showing the thermistor assembly 110. The thermistor assembly 110 incudes a thermistor 111, two lead members 112, and a first resin portion 113.

The thermistor 111 is resistor whose resistance value varies depending on the temperature, for example, such as a Negative Temperature Coefficient (NTC) thermistor and a Positive Temperature Coefficient (PTC) thermistor. The thermistor 111 is, for example, a chip-type thermistor.

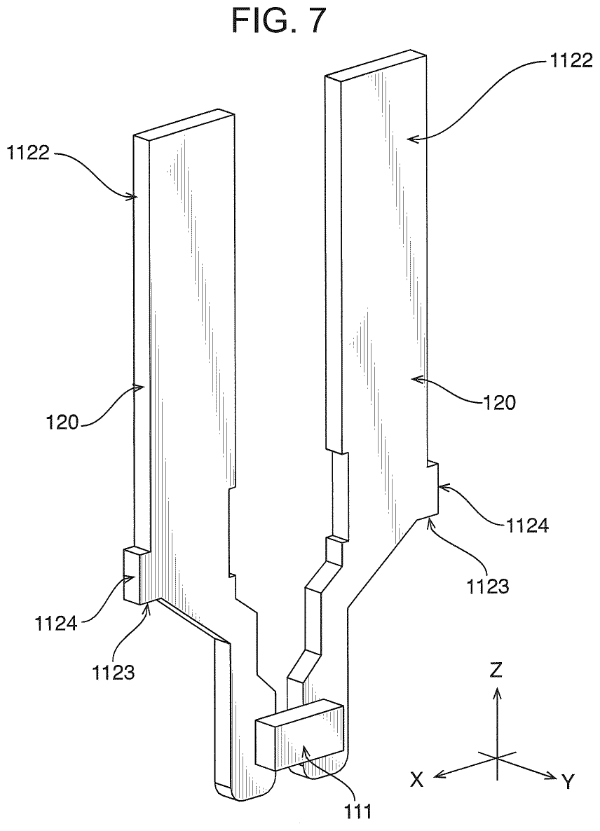

Each of the two lead members 112 includes a first end portion 1121 and a second end portion 1122, and the first end portion 1121 of the lead member 112 is connected with the thermistor 111. That is, as shown in FIG. 7, the thermistor 111 is connected therebetween with the two lead members 112. FIG. 7 is a view for describing the relationship between the thermistor 111 and the two lead members 112, and in FIG. 7, only the thermistor 111 and the two lead members 112 are shown.

The connection of the first end portion 1121 of the lead member 112 and the thermistor 111 is performed by, for example, welding or soldering. The lead member 112 extends from the first end portion 1121 connected with the thermistor 111 toward a first direction (direction Z).

The lead member 112 has the rigidity, that is, the rigidity thereof is high, for example, as shown in FIG. 3, FIG. 6, and FIG. 7, is a metal plate (for example, a lead frame). The lead member 112 may be a metal rod, and may be configured to include both of a metal plate portion and a metal rod portion. A thickness of the metal plate is equal to or larger than a first thickness, and a size of the metal rod may be suitably set to be equal to or larger than a first radius. The first thickness and the first radius are suitably set such that the thermistor assembly 110 is not bent when the thermistor assembly 110 is inserted into the second resin portion 130.

As shown in FIG. 4 and FIG. 6, the first resin portion 113 seals the thermistor 111 so as to protect the thermistor 111. In the lead member 112, the first end portion 1121 connected with the thermistor 111 is sealed by the first resin portion 113, as shown in FIG. 4 and FIG. 6. The second end portion 1122 of the lead member 112 is not sealed by the first resin portion 113 and exists outside the first resin portion 113, as shown in FIG. 6.

The first resin portion 113 is a resin and molded by the transfer molding. That is, the thermistor assembly 110 is manufactured by disposing the thermistor 111 with which the lead member 112 is connected into a mold cavity, then press-fitting heat-softened resin into this cavity, and curing the resin that is press-fitted in this cavity.

As shown above, according to the present embodiment, the first resin portion 113 is molded by the transfer molding so as to have a high rigidity. Also, according to the present embodiment, the lead member 112 has the rigidity and the thermistor 110 has the rigidity as a whole.

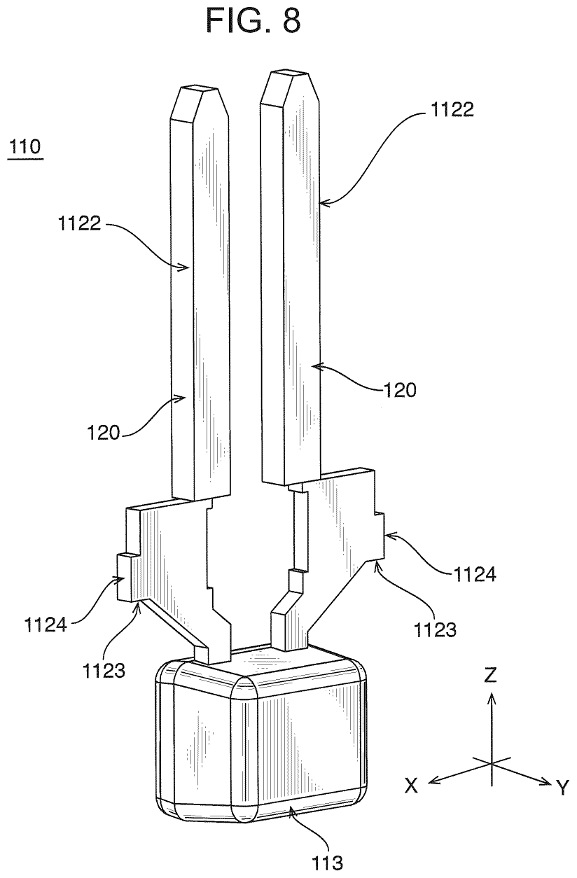

The second end portion 1122 of the lead member 112 is connected with a lead wire 140, as shown in FIG. 6. Also, the second end portion 1122 of the lead member 112 may be in a connector shape, as shown in FIG. 8.

As shown in FIG. 1 and FIGS. 3-5, the case 120 has an accommodation area CA, and the accommodation area CA opens in a second direction (direction X). The thermistor assembly 110 is accommodated in the accommodation area CA of the case 120.

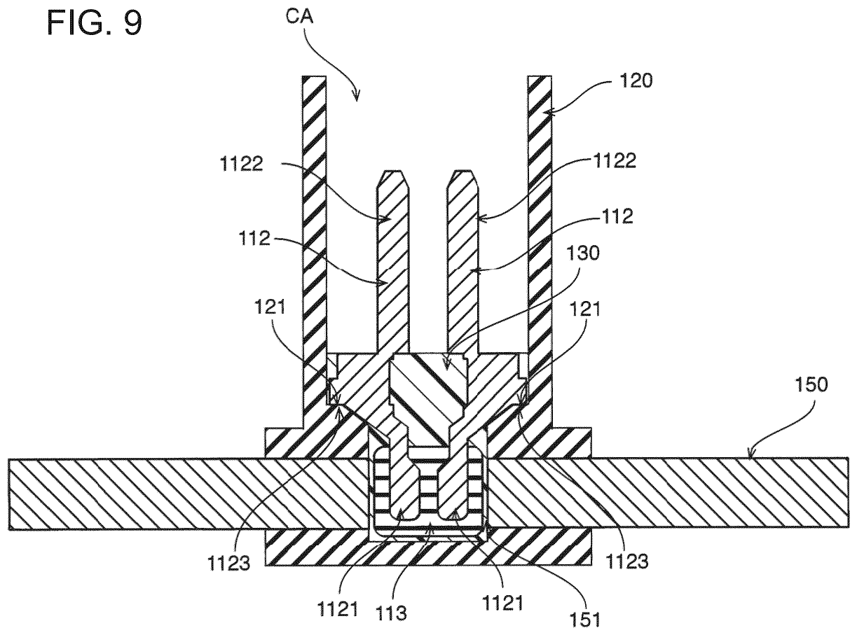

The second resin portion 130 is a resin, and is disposed inside the accommodation area CA of the case 120 so as to seal the first resin portion 113, as shown in FIG. 3 and FIG. 4. In a case in which the lead wire 140 is connected with the second end portion 1122 of the lead member 112, for example, as shown in FIG. 3, the second resin portion 130 is disposed in the accommodation area CA of the case 120 so as to seal the entire thermistor assembly 110. Also, in a case in which the second end portion 1122 of the lead member 112 is a connector shaped, as shown in FIG. 9, the second resin portion 130 is disposed inside the accommodation area CA of the case 120 such that the connector-shaped portion is outside the second resin portion 130. FIG. 9 is a view showing the relationship between the lead member 112 and the second resin portion 130.

For example, before curing, the second resin portion 130 is injected into the accommodation area CA of the case 120. Then, the thermistor assembly 110 is inserted into the second resin portion 130 that is injected into the accommodation area CA of the case 120 such that the first resin portion 113 is sealed by the second resin portion 130. Then, the second resin portion 130 is cured in the state of sealing this first resin portion 113.

According to the present embodiment, as shown above, in the present embodiment, the thermistor assembly 110 has the rigidity as a whole. Accordingly, according to the present embodiment, when the thermistor assembly 110 is inserted into the second resin portion 130, it is possible to accurately position the thermistor 11 with respect to the case 120 without the thermistor assembly 110 being bent. As a result, it is possible to provide the temperature sensor in which the thermistor is accurately positioned with respect to the case.

At this time, as shown in FIG. 3, the lead member 112 and the case 120 include first guide portions 1123, 121, respectively, for positioning the thermistor 111 with respect to the case 120 in the first direction (direction Z). In the example shown in FIG. 3, the first guide portion 1123 of the lead member 112 is a surface facing the opposite direction (direction −Z) of the first direction, and the first guide portion 121 of the case 120 is a surface facing the first direction (direction Z). The thermistor assembly 110 is fixed to the case 120 such that the two surfaces are in contact with each other such that it becomes possible to accurately position the thermistor 111 with respect to the case 120 in the first direction (direction Z).

Also, as shown in FIG. 5, the lead member 112 and the case 120 may further include second guide portions 1124, 122, respectively, for positioning the thermistor 111 with respect to the case 120 in a plane orthogonal to the first direction. In the example shown in FIG. 5, the second guide portion 122 of the case 120 is a groove extending from the accommodation area CA in the second direction (direction X) and the opposite direction (direction −X) of the second direction, and the second guide portion 1124 of the lead member 112 is a portion fitting into this groove in the lead member 112. In the example shown in FIG. 5, the thickness of the groove is set that the lead member 112 comes into contact with the bottom of the groove, and the width of this groove in a third direction (direction Y) is set to be equal to the thickness of the lead member 112 in the third direction. Accordingly, in the example shown in FIG. 5, it is possible to accurately position the thermistor 111 with respect to the case 120 on the plane orthogonal to the first direction (direction Z).

The temperature sensor 100 may further include a connection member 150. The connection member 150 is a member for connecting with a measurement target of the temperature sensor 100. Accordingly, the case 120 includes an insertion port 123 for inserting this connection member 150, and the connection member 150 is inserted into this insertion port 123.

For example, the connection member 150 is a member with a high thermal conductivity. When the connection member 150 is connected with the measurement target, the temperature of the connection member 150 becomes the same with that of the measurement target. Also, the connection member 150 is a conductor. In a case in which the measurement target is the conductor through which a current flows, when the connection member 150 is connected with the measurement target, the current flowing through the measurement target flows through the connection member 150, and the temperature of the connection member 150 becomes the same with that of the measurement target.

For example, the connection member 150 has a hole 151. At this time, the connection member 150 is inserted into the insertion hole 123 of the case 120 such that the thermistor 111 is positioned inside the hole 151. In this manner, the thermistor 111 is surrounded by the connection member 150 so as to not to be affected by the temperature of other members such that it is possible to measure the temperature of the connection member 150 (that is, the temperature of the measurement target) with a suitable precision. The hole 151 is, for example, a penetration hole.

### Manufacturing Method of Temperature Sensor 100

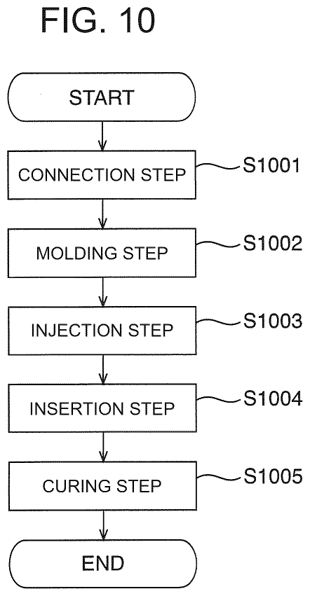

FIG. 10 is a view showing an example of a manufacturing method of the temperature sensor 100. According to the manufacturing method shown in FIG. 10, at first, the thermistor assembly 110 is manufactured, and then, the manufactured thermistor assembly 110 is used to manufacture the temperature sensor 100.

The thermistor 111 is connected to the first end portions 1121 of the two lead members 112 (connection step, Step S1001). Then, the first resin portion 113 is molded by the transfer molding (molding step, Step S1002) such that the thermistor 111 is sealed by the first resin portion 113. The thermistor assembly 110 is manufactured by these connection step (Step S1001) and the molding step (Step S1002).

Thereafter, in the accommodation area CA of the case 120, the resin is injected (injection step, Step S1003). The injected resin is the resin of the second resin portion 130 before being cured.

Then, the thermistor assembly 110 is inserted into this resin (injection step, Step S1004) such that the first resin portion 113 is sealed by the resin injected into the accommodation area CA of the case 120. At this time, the thermistor assembly 110 is inserted such that the first guide portion 1123 of the lead member 112 comes into contact with the first guide portion 121 of the case 120. In this manner, the thermistor 111 is accurately positioned with respect to the case 120 in the first direction (direction Z). Also, the thermistor assembly 110 is inserted such that the second guide portion 1124 of the lead member 112 fits into the groove (second guide portion 122) of the case 120. In this manner, the thermistor 111 is accurately positioned with respect to the case 120 on the plane orthogonal to the first direction (direction Z).

At last, the resin injected into the accommodation area CA of the case 120 is cured (curing step, Step S1005). In this manner, the resin injected into the accommodation area CA of the case 120 is cured and disposed inside the accommodation area CA of the case 120 such that the first resin portion 113 is sealed by the second resin portion 130, and the temperature sensor 100 is completed.

It is noted that the above-described embodiment merely shows a typical aspect of the present invention, and the present invention is not limited to this embodiment. That is, various modifications can be made without departing from the spirit of the present invention. Such modifications are, of course, included within the scope of the present invention as long as they still have the structure according to the present invention.

### REFERENCE SIGNS LIST

100 temperature sensor
110 thermistor assembly
111 thermistor of thermistor assembly 110
112 lead member of thermistor assembly 110
1121 first end portion of lead member 112
1122 second end portion of lead member 112
1123 first guide portion of lead member 112
1124 second guide portion of lead member 112
113 first resin portion of thermistor assembly 110
120 case
121 first guide portion of case 120
122 second guide portion of case 120
123 insertion port of case 120
130 second resin portion
140 lead wire
150 connection member
151 hole of connection member 150

What is claimed is:

1. A thermistor assembly, comprising:
a thermistor,
two lead members with rigidity; and
a first resin portion,
wherein first end portions of the two lead members are connected with the thermistor, and
the thermistor is sealed by the first resin portion.

2. The thermistor assembly according to claim 1, wherein each of the two lead members is a metal plate.

3. The thermistor assembly according to claim 1, wherein the first resin portion is molded by a transfer molding.

4. The thermistor assembly according to claim 1, wherein each of the two lead members is provided with a second end portion of the corresponding lead member with which a lead wire is connected.

5. The thermistor assembly according to claim 1, wherein a shape of the second end portion of each one of the two lead members is a connector shape.

6. A temperature sensor, comprising:
the thermistor assembly according to claim 1;
a case having an accommodation area that is open in a second direction; and
a second resin portion,
wherein the second resin portion is disposed in the accommodation area so as to seal the first resin portion.

7. The temperature sensor according to claim 6, further comprising a connection member for connecting with a measurement target,
wherein the connection member includes a hole,
the case includes an insertion port into which the connection member is inserted, and
the connection member is inserted into the insertion port of the case such that the thermistor is positioned inside the hole.

8. The temperature sensor according to claim 7, wherein the lead member and the case have first guide portions respectively for positioning the thermistor with respect to the case in the first direction.

9. A manufacturing method for manufacturing a thermistor assembly, comprising:
a connection step of connecting a thermistor to first end portions of two lead members having rigidity; and
a molding step of molding a first resin portion by a transfer molding such that the thermistor is sealed by the first resin portion.

10. A manufacturing method for manufacturing a temperature sensor, comprising:
a connection step of connecting a thermistor to first end portions of two lead members having rigidity;
a molding step of molding a first resin portion by a transfer molding such that the thermistor is sealed by the first resin portion;
an injection step of injecting resin into an accommodation area of a case;
an insertion step of inserting the thermistor assembly into the resin such that the first resin portion is sealed by the resin that is injected into the accommodation area of the case, and
a curing step of curing the resin.
